(19) United States
(12) Patent Application Publication
(10) Pub. No.: US 2014/0190078 A1
(43) Pub. Date: Jul. 10, 2014

(54) DOMESTIC PLANT FACTORY CAPABLE OF AIR PURIFICATION

(71) Applicant: Dall Woo Kim, Cheongju-si (KR)

(72) Inventor: Dall Woo Kim, Cheongju-si (KR)

(73) Assignee: SUNGBO TECHNOLOGY CO., LTD, Cheongju-si (KR)

(21) Appl. No.: 13/994,202

(22) PCT Filed: Aug. 28, 2012
(86) PCT No.: PCT/KR2012/006848

§ 371 Date: Jun. 14, 2013

(30) Foreign Application Priority Data
Sep. 15, 2011 (KR) 10-2011-0093049

(51) Int. Cl. A01G 31/02

(52) U.S. Cl. CPC A01G 31/02
USPC 47/62 A

(57) ABSTRACT

The present invention relates to a domestic plant factory able to achieve the aims of reducing hydroponic culture costs and improving air quality, wherein a culture solution is supplied to plants through salt ions generated while removing atmospheric NOX, SOX, PM10, HOCL and the like using an effective microbe fermented solution and a porous filtering medium. The domestic plant factory includes: a casing having a space therein and provided at an upper side thereof with a placement hole; a cultivation cup fixedly placed in the placement hole and provided on a wall thereof with a plurality of through-holes; a rooting member including a vegetation filtering medium charged in the casing or the cultivation cup; and an air supply unit supplying air to water charged in the space of the casing.

### CROSS REFERENCE RELATED APPLICATION

This application claims foreign priority of Korean Patent Application No. 10-2011-0093049, filed on Sep. 15, 2011, which is incorporated by reference in their entirety into this application.

### TECHNICAL FIELD

The present invention relates to a domestic plant factory capable of purifying air, and, more particularly, to a domestic plant factory, which can remove NO_{X}, SO_{X}, PM10, HOCL and the like from air using an effective microbe fermented solution and a porous filtering medium.

### BACKGROUND ART

In conventional hydroponic culture, a culture solution is provided in order to supply nutrients necessary for plant cultivation. Therefore, there is a problem in that an additional cost is required for hydroponic culture.

Further, when domestic hydroponic culture is conducted, there is an effect of reducing carbon dioxide using the photosynthesis of plants, but the effect thereof is insufficient. Moreover, since plants conduct oxygen respiration in the absence of light, the effect of reducing carbon dioxide becomes more insufficient.

Further, although many persons conduct hydroponic culture in order to improve indoor air quality, there has not been proposed a hydroponic culture method that can remove atmospheric NO_{X}, SO_{X}, PM10, HOCL and the like generated from residential areas.

### DISCLOSURE

### Technical Problem

Accordingly, the present invention has been devised to solve the above-mentioned problems, and an object of the present invention is to provide a domestic plant factory, wherein a culture solution can be supplied to plants through salt ions generated while removing atmospheric NOX, SOX, PM10, HOCL and the like using an effective microbe fermented solution and a porous filtering medium.

### Technical Solution

In order to accomplish the above object, an aspect of the present invention provides a domestic plant factory, including: a casing having a space therein and provided at an upper side thereof with a placement hole; a cultivation cup fixedly placed in the placement hole and provided on a wall thereof with a plurality of through-holes; a rooting member including a vegetation filtering medium charged in the casing or the cultivation cup; and an air supply unit supplying air to water charged in the space of the casing.

Here, the casing may be made of a transparent material.

Further, the air supply unit may include: a blower fan for pressurizing air; a porous tube provided on an outer circumference thereof with a plurality of exhaust holes to receive air supplied from the blower fan through an air supply pipe and discharge the air in the form of air bubbles; and a circulation pipe provided around the porous tube in the length direction of the casing.

Further, the vegetation filtering medium may be a porous filtering medium including effective microbes for providing a microbe fermented solution.

The effective microbes may include aerobes, anaerobes or facultative anaerobes including one or more selected from among bacillus sp, sphaericus, thuringiensis, megaterium, pumilus, and nitrate bacteria.

Further, the porous filtering medium may be any one selected from among axinite, zeolite, scoria, glass fiber, and elvan.

The domestic plant factory may further include: an LED unit disposed on the casing to provide light necessary for plant growth; and a light intensity control unit controlling light intensity of the LED unit.

Further, the through-holes of the cultivation cup may include upper through-holes disposed on an upper side of the cultivation cup and lower through-holes disposed on a lower side of the cultivation cup, and the upper through-holes and the lower through-holes may be spaced apart from each other in the length direction of the cultivation cup.

### Advantageous Effects

According to the domestic plant factory of the present invention, hydroponic culture can be conducted without an additional culture solution, and pollutants can be removed from indoor air.

Further, if necessary, a nutrient may be additionally supplied to plants depending on the kind of plants.

### DESCRIPTION OF DRAWINGS

FIG. 1 is a schematic sectional view showing a domestic plant factory capable of purifying air according to an embodiment of the present invention.

### BEST MODE

Hereinafter, a preferred embodiment of the present invention will be described in detail with reference to the accompanying drawing. In the description of the present invention, when it is determined that detailed descriptions of commonly-known functions and constitutions would obscure the gist of the present invention, the detailed descriptions thereof will be omitted.

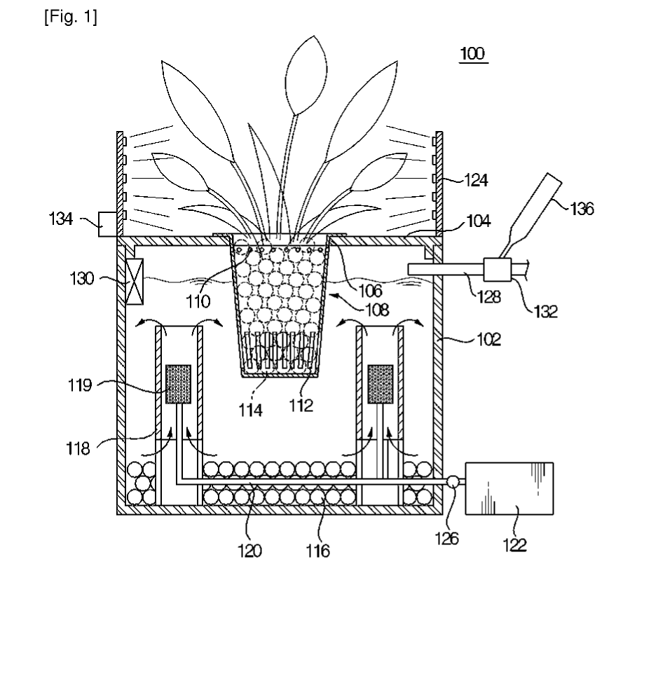

In FIG. 1, the reference numeral “100” indicates a domestic plant factory according to an embodiment of the present invention.

The domestic plant factory 100 includes a casing 102 having an inner space, a cultivation cup 108 hanging under the top of the casing 102, vegetation filtering media 114 and 116 charged in the casing 102 and the cultivation cup 108, and an air supply unit.

The casing 102 is made of a watertight material, and is provided with a space therein. This space is filled with water. Particularly, it is preferred that the casing 102 be made of a transparent material such as acryl resin or the like such that the domestic plant factory 100 is easily observed from the outside.

The top portion of the casing 102 is closed. In an embodiment of the present invention, the top portion of the casing 102 is closed by an additional cover 104, but the cover 104 may be integrated with the casing 102.

The cover 104 is provided with a placement hole 106. The cultivation cup 108 is inserted into the placement hole 106 to be fixed under the cover 104. In order for the cultivation cup 108 to be easily inserted and fixed, the cultivation cup 108 may be provided at the upper end thereof with a flange.

The raw material of the cultivation cup 108 is not limited, but it is preferred that the cultivation cup 108 be made of a synthetic resin that is easily formed into a desired shape. Since the growth of the root of a hydroponically-cultivated plant is inhibited by externally-introduced light, the cultivation cup 108 may be made of an opaque material. For example, the cultivation cup 108 may be black.

A plurality of through-holes 110 and 112 are formed on the outer circumference of the cultivation cup 108. The through-holes 110 and 112 function as air exhaust ports for discharging the air supplied by the air supply unit to the outside of the cultivation cup 108, and function as water passage holes through which water charged in the casing 102 can easily move. Therefore, in an embodiment of the present invention, the through-holes 110 and 112 are classified into upper through-holes 110 and lower through-holes 112. Here, the upper through-holes 110 function as air exhaust ports, and the lower through-holes 112 function as water passage holes. Therefore, the upper through-holes 110 and the lower through-holes 112 are spaced apart from each other in the length direction of the cultivation cup 108, and the level of water charged in the casing 102 is higher than the lower through-holes 112 and lower than the upper through-holes 112. Thanks to the upper through-holes, an air exhaust pipe need not be additionally provided, so the number of components constituting the domestic plant factory 100 can be reduced. The lower through-holes 112 may be formed on the bottom side as well as lateral sides of the cultivation cup 108.

The air supply unit includes: a blower fan 122 which is fixed on the outer wall of the casing 102 to pressurize air;

porous tubes 119, each of which is provided on the outer circumference thereof with a plurality of exhaust holes to receive air supplied from the blower fan 122 through an air supply pipe 120 and discharge the air in the form of air bubbles; and circulation pipes 118, each of which is provided around each of the porous tubes 119. The circulation pipe 118 is disposed such that its inner wall is spaced apart from the outer circumference of the porous tube 119.

Therefore, when a large number of air bubbles are generated by the porous tube 119, they ascend in the circulation pipe 118, and thus water also ascends in the circulation pipe 118. Therefore, the pressure in the circulation pipe 118 becomes lower than the pressure therearound, and thus water staying around the circulation pipe 118 is introduced into the circulation pipe 118. As a result, water is discharged to the outside of the circulation pipe 118 through the upper portion of the circulation pipe 118, and is continuously introduced into the lower portion thereof to circulate water in the casing 102.

Due to the circulation of water, water moves up and down in the casing 102, thus stirring the water. For this reason, the contact time and contact frequency of water and air increase, and thus air can be sufficiently dissolved in water. In this case, the vegetation filtering media 114 and 116 charged in the cultivation cup 108 and the casing 102 come into contact with air-containing water, so air is supplied to microbes, and these microbes make an effective microbe fermented solution.

The vegetation filtering media 114 and 116 are porous filtering media including an effective microbe fermented solution as a plant nutrient. Here, effective microbes may include aerobes, anaerobes or facultative anaerobes including one or more selected from among bacillus sp, sphaericus, thuringiensis, megaterium, pumilus, and nitrate bacteria. Here, as commonly known, bacillus sp functions to decompose organic matter and remove a bad smell from air, sphaericus functions to eliminate insects or disease-causing bacteria, thuringiensis functions to kill insects, particularly, mosquitoes, megaterium functions to decompose solidified matter using a protease, pumilus functions to kill bacteria, and nitrate bacteria function to oxidize an nitrous acid group dissolved in water to produce nitrates.

Further, the porous filtering medium may be any one selected from among axinite, zeolite, scoria, glass fiber and elvan.

Therefore, the vegetation filtering media 114 and 116 can produce NO₃ using NO_{X} in air, and can supply the NO₃ to plants. Plants can use this NO₃ as a nitrogenous fertilizer. Further, the vegetation filtering media 114 and 116 can produce a sulfur-containing fertilizer using So_{X} in air, and can supply the sulfur-containing fertilizer to plants. Moreover, vegetation filtering media 114 and 116 can remove PM10, HOCL and the like from air.

Meanwhile, an LED unit 124 for providing light necessary for plant growth may be disposed on the casing 102. Since the

LED unit 124 can supply light to plants at a desired time, a light intensity necessary for each plant is provided, so it is possible to cultivate long-day plants and the like regardless of seasons. The LED unit 124 may include: a plurality of LEDs arranged on a beam or plate set up on the casing 102; an electricity supply unit for supplying electricity to the LEDs; and a light intensity control unit 134 for controlling light intensity caused by the LEDs. Thanks to the light intensity control unit 134, light suitable for different characteristics of plants can be provided according to the kinds of plants.

Further, the casing 102 is provided therein with a liquid supply pipe 128, and the liquid supply pipe 128 is connected with a water supply source (not shown). Further, the liquid supply pipe 128 is provided with a connector 132 to replenish a nutrient-insufficient microbe fermented solution with nutrients using a commercially available culture solution container 136.

Further, a level sensor 130 is provided in the casing 102 to maintain the water level in the casing 102 constant.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The domestic plant factory has improved reliability and competitiveness and can be usefully used in the field of hydroponic culture and hydroponic cultivation apparatus.

1. A domestic plant factory, comprising:
a casing having a space therein and provided at an upper side thereof with a placement hole;
a cultivation cup fixedly placed in the placement hole and provided on a wall thereof with a plurality of through-holes;
a rooting member including a vegetation filtering medium charged in the casing or the cultivation cup; and
an air supply unit supplying air to water charged in the space of the casing.

2. The domestic plant factory of claim 1, wherein the casing is made of a transparent material.

3. The domestic plant factory of claim 1, wherein the air supply unit comprises: a blower fan for pressurizing air; a porous tube provided on an outer circumference thereof with a plurality of exhaust holes to receive air supplied from the blower fan through an air supply pipe and discharge the air in the form of air bubbles; and a circulation pipe provided around the porous tube in the length direction of the casing.

4. The domestic plant factory of claim 1, wherein the vegetation filtering medium is a porous filtering medium including effective microbes for providing a microbe fermented solution.

5. The domestic plant factory of claim 4, wherein the effective microbes include aerobes, anaerobes or facultative anaerobes including one or more selected from among bacillus sp, sphaericus, thuringiensis, megaterium, pumilus, and nitrate bacteria.

6. The domestic plant factory of claim 4, wherein the porous filtering medium is any one selected from among axinite, zeolite, scoria, glass fiber, and elvan.

7. The domestic plant factory of claim 1, further comprising: an LED unit disposed on the casing to provide light necessary for plant growth; and a light intensity control unit controlling light intensity of the LED unit.

8. The domestic plant factory of claim 1, wherein the through-holes of the cultivation cup include upper through-holes disposed on an upper side of the cultivation cup and lower through-holes disposed on a lower side of the cultivation cup, and the upper through-holes and the lower through-holes are spaced apart from each other in the length direction of the cultivation cup.
